(19) United States
(12) Patent Application Publication
(10) Pub. No.: US 2016/0329122 A1
(43) Pub. Date: Nov. 10, 2016

(54) CONDUCTIVE PASTE AND CONDUCTIVE FILM

(71) Applicant: NIPPONKAYAKU KABUSHIKIKAISHA, Tokyo (JP)

(72) Inventors: Kazunori ISHIKAWA, Ibaraki (JP); Go MIZUTANI, San Jose, CA (US); Junichi SEGAWA, Tokyo (JP)

(73) Assignee: NIPPONKAYAKU KABUSHIKIKAISHA, Tokyo (JP)

(21) Appl. No.: 15/107,621

(22) PCT Filed: Dec. 25, 2014
(86) PCT No.: PCT/JP2014/084325

§ 371 Date: Jun. 23, 2016

(30) Foreign Application Priority Data
Dec. 27, 2013 (JP) 2013-272003

(51) Int. Cl. H01B 1/22; C09D 7/12; C09D 179/08; C09D 5/24

(52) U.S. Cl. CPC H01B 1/22; C09D 5/24; C09D 7/1291; C09D 179/08; C08K 7/00

(57) ABSTRACT

Provided is a conductive paste containing: a binder resin containing at least an aromatic polyimide resin (A) having a phenolic hydroxyl group and an ether linkage in a skeleton, and conductive particles. The polyimide resin (A) is preferably the resin of formula (1). (R₁ represents formula (2), R₂ represents formula (3), and R₃ represents a divalent aromatic group having at least one of the structures illustrated in formula (4).

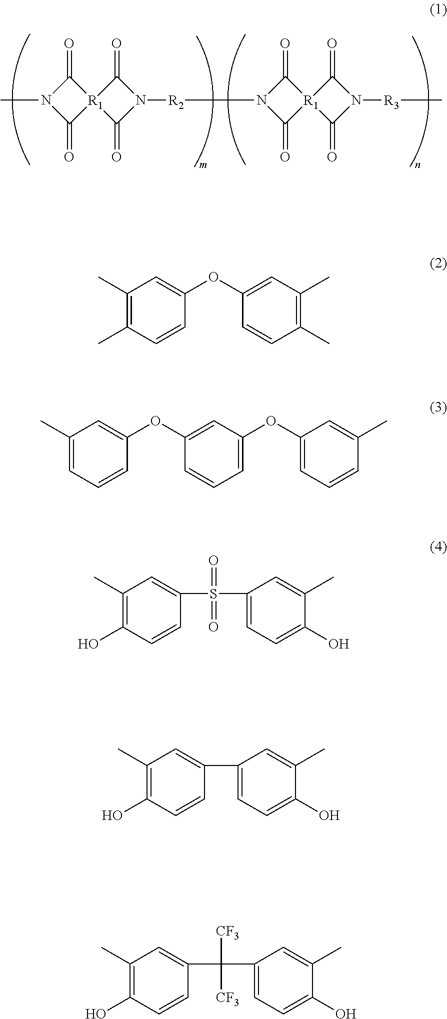

### TECHNICAL FIELD

The present invention relates to a conductive paste and a conductive film which comprise a binder resin and conductive particles, have low volume resistivity and excellent heat resistance and adhesive properties, and are used for connecting electronic components to a substrate, wherein the binder resin is at least an aromatic polyimide resin containing an ether linkage and a phenolic hydroxyl group in a skeleton.

### BACKGROUND ART

In the assembly of electronic equipment or the mounting process of electronic components, solder junction is widely utilized as means to achieve conductive connection between circuit wiring and each electronic component. However, in recent years, the lead contained in solder has been regarded as problematic due to the increased recognition of environment, and the establishment of a lead-free mounting technology has been an urgent requirement. As the lead-free mounting technology, there has been proposed a method in which lead-free solder or an electrically conductive adhesive is used instead of conventional solder for the connection between a substrate electrode and an electronic component. If repeated stress is applied when a substrate electrode and an electronic component are connected using solder, application of repeated stress may cause failure by metal fatigue to generate a crack in a connection section. On the other hand, when a substrate electrode and an electronic component are connected using a conductive paste comprising a binder resin and conductive particles as an electrically conductive adhesive, the connection section is bonded with a resin, and therefore this method has an advantage that the connection section can flexibly respond to deformation. Thus, the method in which a conductive paste is used has advantages not only in terms of environmental issues but also in terms of connection reliability, and the conductive paste attracts attention particularly as a connecting material between a substrate electrode and an electronic component. With respect to such a conductive paste, there is disclosed a method in which silver powder or copper powder is dispersed in an epoxy resin or a phenolic resin.

Further, although a resin substrate has been used as a flexible substrate in recent years, such a substrate may be damaged when heating temperature exceeds 200° C. Therefore, a conductive paste for forming a conductive material on a substrate is required to be cured by heating at 200° C. or less.

Further, after a step of mounting electronic components on a substrate, it is sometimes desired to perform the steps of: temporarily curing a conductive paste, covering the connection section between a substrate electrode and the electronic component with a sealing resin, and curing the temporarily-cured conductive paste and the sealing resin in this order, which enables a reduction in production time. Note that “temporarily curing” means changing a conductive paste to a state referred to as the “stage B” (hereinafter referred to as a conductive film). A conductive paste comprising a binder resin and conductive particles can easily prepare the conductive film.

In a conventional conductive paste or a conductive film, electrical conductivity is developed by mechanical contact of micro-sized conductive particles, for example, silver particles, in the inner part of a binder resin. In this case, since the silver particles contact each other through an electrically insulated barrier layer comprising a resin and the like, interfacial electrical resistance increases, and electrical conductivity tends to be suppressed. To suppress an increase in electrical resistivity of a conductive paste or a conductive film, it is effective to sinter silver particles in the inner part of a binder resin. Therefore, it is expected to achieve sintering even at a low temperature of 200° C. or less using silver particles having a small average particle size. For example, Patent Literature 1 discloses a technique of using spherical nano-sized silver particles and rod-shaped nano-sized silver particles in combination to achieve sintering at low temperatures to obtain stable electrical conductivity.

However, in the case where nano-sized silver particles are used, if the sintering is performed at low temperatures using a large amount of conductive paste in order to form a thick conductive layer, the silver particles in the vicinity of the central part of the formed conductive material will remain unburnt and interfacial electrical resistance cannot sufficiently be suppressed in the unsintered region. Therefore, the electrical resistivity tends to increase. Further, since nano-sized silver particles are used, the material cost tends to increase. Furthermore, there are various problems in using nano-sized silver particles, and examples of the problems include a large degree of shrinkage in a curing process, the health hazard caused by the toxicity of the nano-sized silver particles, and high material cost. In addition to these problems, a conductive paste intended for sintering silver particles by heating at low temperatures tends to be a conductive paste having a low adhesive force since the amount of a binder resin which tends to act as an inhibitor for the sintering of silver particles is suppressed.
Patent Literature 1: Japanese Patent No. 4517230

### DISCLOSURE OF THE INVENTION

### Technical Problem

Thus, a conventional conductive paste has a problem of having a higher resistivity than that of solder. A conductive paste is obtained by dispersing conductive particles in a binder resin, and a method for reducing the resistivity includes increasing the content of conductive particles. For example, in a conventional conductive paste, the content of conductive particles is increased to about 80 to 90% by weight to achieve a resistivity suitable for practical use. However, if the content of conductive particles is increased, there will be such a problem that the content of a binder resin may be reduced with the increase in the content of conductive particles, to thereby reduce the adhesive strength. Further, if a conventional epoxy resin is used as a binder resin, there will also be such a problem that use of the conventional epoxy resin in a place at a temperature of 170° C. or more will be limited because the glass transition temperature of the conventional epoxy resin is generally 170° C. or less.

### Solution to Problem

As a result of extensive and intensive studies, the present inventors have found that a conductive paste and a conductive film in which an aromatic polyimide resin (A) containing an ether linkage and a phenolic hydroxyl group in a skeleton is used as a binder resin can solve the above problems and have completed the present invention.

Specifically, the present invention relates to:

(1) A conductive paste comprising: a binder resin containing at least one aromatic polyimide resin (A) having an ether linkage and a phenolic hydroxyl group in a skeleton; and conductive particles;
(2) The conductive paste according to (1), wherein the polyimide resin (A) is represented by the following formula (1):

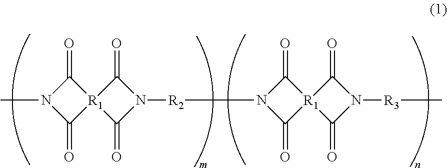

wherein m and n are each an average value of the number of repeating units and a positive number satisfying the relations of 0.005<n/(m+n)<0.14 and 0<m+n<200; R₁ represents a tetravalent aromatic group represented by the following formula (2):

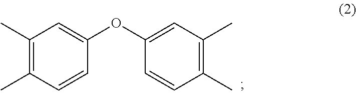

R₂ represents a divalent aromatic group represented by the following formula (3):

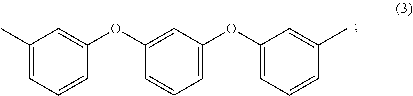

and
R₃ represents one or more divalent aromatic groups selected from structures represented by the following formula (4):

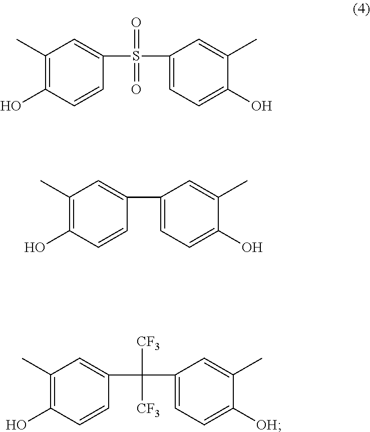

(3) The conductive paste according to (1) or (2), wherein the content of the polyimide resin (A) is 50% by weight or more and 100% by weight or less based on the total weight of the binder resin;
(4) The conductive paste according to any one of (1) to (3), wherein the binder resin further contains an epoxy resin;
(5) The conductive paste according to (4), wherein the content of the epoxy resin is 5% by weight or more and 50% by weight or less based on the binder resin;
(6) The conductive paste according to any one of (1) to (5), wherein the conductive particles are silver particles each having a shortest diameter of 1 μm or more;
(7) The conductive paste according to any one of (1) to (6), wherein the conductive particles comprise plate-shaped silver particles;
(8) The conductive paste according to (7), wherein the silver particles further comprise one or more selected from spherical silver particles and indefinite-shaped silver particles; and
(9) A conductive film obtained by processing the conductive paste according to any one of (1) to (8) into a sheet shape.

### Advantageous Effects of Invention

In the conductive paste of the present invention, conductive particles such as silver particles are sintered by low-temperature heating, and a conductive film having low electrical resistivity can be formed. Further, since a specific polyimide is used in the conductive film obtained by processing the conductive paste of the present invention into a sheet shape and a cured product thereof, the film and the cured product have a high glass transition point and heat resistance higher than that of conventionally used epoxy resins. Further, since the film and the cured product are excellent in flame retardancy and adhesive properties, they can widely be used for producing a flexible printed wiring board and are extremely useful in the field of electrical materials such as an electrical board.

### DESCRIPTION OF EMBODIMENTS

The conductive paste and the conductive film according to the present invention comprise conductive particles and a binder resin containing an aromatic polyimide resin (A) having an ether linkage and a phenolic hydroxyl group in a skeleton. Here, the aromatic polyimide resin (A) can be used without particular limitation as long as it has an ether linkage and a phenolic hydroxyl group in a skeleton. Since such an aromatic polyimide resin (A) has a high glass transition point, it has good heat resistance. Note that the binder resin may further contain, in addition to the polyimide resin (A), other resins in the range that does not impair the function of the conductive paste, and, for example, an epoxy resin, a curing agent thereof and a curing accelerator thereof, and the like may be contained.

A preferable polyimide resin (A) in the present invention is an aromatic polyimide resin obtained by the addition reaction of a tetracarboxylic dianhydride represented by the following formula (5):

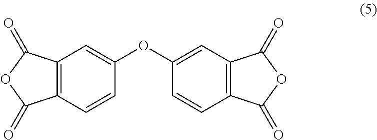 [SMILES: O=C1OC(=O)c2cc(Oc3ccc4c(c3)C(=O)OC4=O)ccc21]

with a diamine compound represented by the following formula (6):

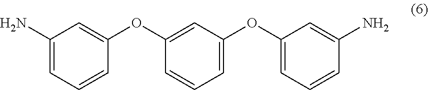 [SMILES: Nc1cccc(Oc2cccc(Oc3cccc(N)c3)c2)c1]

and at least one diaminodiphenol compound selected from the following formula (7):

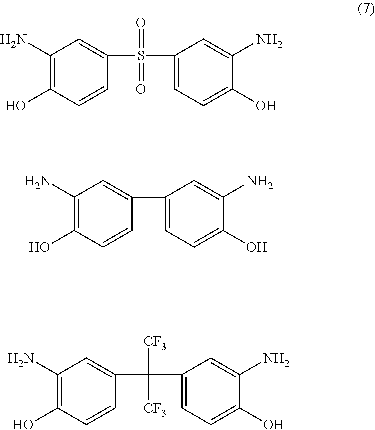 [SMILES: Nc1cc(S(=O)(=O)c2ccc(O)c(N)c2)ccc1O ; Nc1cc(-c2ccc(O)c(N)c2)ccc1O ; Nc1cc(C(c2ccc(O)c(N)c2)(C(F)(F)F)C(F)(F)F)ccc1O]

to obtain a polyamic acid, followed by dehydration ring-closing reaction of the polyamic acid thus obtained. A series of these reactions are preferably performed in one pot without using a plurality of reactors.

By passing through the steps as described above, a phenolic hydroxyl group-containing aromatic polyimide resin (A) (hereinafter sometimes simply referred to as a polyimide resin of the present invention) is obtained, which has, in the structure, a repeating unit represented by the following formula (1):

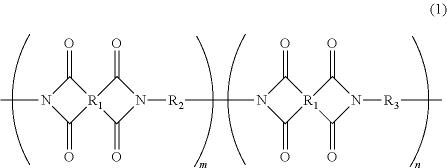

wherein m and n are each an average value of the number of repeating units and a positive number satisfying the relations of 0.005<n/(m+n)<0.14 and 0<m+n<200; represents a tetravalent aromatic group represented by the following formula (2):

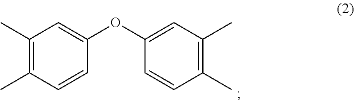

R₂ represents a divalent aromatic group represented by the following formula (3):

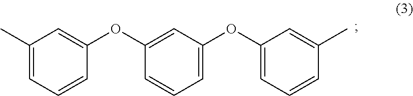

and
R₃ represents at least one selected from divalent aromatic group structures described in the following formula (4):

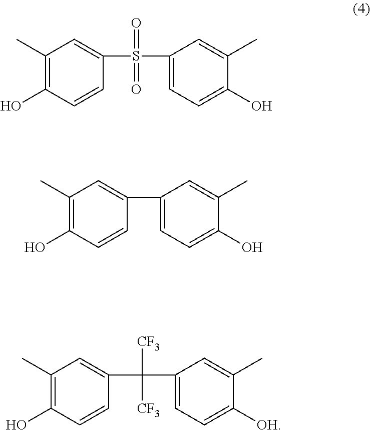

In the polyimide resin (A) of the present invention, the molar ratio of the diamine compound to the diaminodiphenol compound, which are raw materials, is theoretically the ratio of m to n in the above formula (1). The values of m and n are generally 0.005<n/(m+n)<0.14 and 0<m+n<200. When the values of m and n are within the ranges as described above, the hydroxyl group equivalent of the phenolic hydroxyl group in one molecule of the polyimide resin (A) and the molecular weight of the polyimide resin (A) are suitable values for exhibiting the effects of the present invention. The values of m and n are more preferably 0.01<n/(m+n)<0.06, further preferably 0.015<n/(m+n)<0.04. When the values of m and n are 0.005<n/(m+n), the glass transition temperature of the film after adhesion is 200° C. or more, which is preferred.

The average molecular weight of the polyimide resin (A) of the present invention is preferably 1,000 to 70,000 in terms of number average molecular weight and 5,000 to 500,000 in terms of weight average molecular weight. When the number average molecular weight is 1,000 or more, mechanical strength develops, which is preferred. Further, when the number average molecular weight is 70,000 or less, adhesive properties develop, which is preferred.

The molecular weight of the polyimide resin (A) of the present invention can be controlled by adjusting the molar ratio, R value, of the sum of diamine and diaminodiphenol to tetracarboxylic dianhydride, which are used in the reaction, [=(diamine+diaminodiphenol)/tetracarboxylic dianhydride]. The closer the R value is to 1.00, the larger the average molecular weight become. The R value is preferably 0.80 to 1.20, more preferably 0.9 to 1.1.

When the R value is less than 1.00, the terminal of the polyimide resin (A) of the present invention is an acid anhydride, and when the R value is more than 1.00, the terminal is amine or aminophenol. The terminal of the polyimide resin (A) of the present invention is not limited to one of such structures, but is preferably amine or aminophenol.

Note that the terminal groups of the polyimide resin (A) of the present invention can chemically be modified for adjusting heat resistance and curing characteristics. For example, an addition reaction product of the polyimide resin (A) of the present invention having an acid anhydride in the terminal with glycidol, or a polycondensate of the polyimide resin (A) of the present invention having an amine or aminophenol in the terminal and 4-ethynylphthalic anhydride, is an example of the preferred embodiments of the present invention.

The addition reaction and the dehydration ring-closing reaction are preferably performed in a solvent that dissolves a polyamic acid which is an intermediate of the synthesis and the polyimide resin (A) of the present invention, for example, a solvent containing one or more selected from N-methyl-2-pyrrolidone, N,N-dimethylacetamide, and γ-butyrolactone.

In the dehydration ring-closing reaction, it is preferred to perform the reaction using a small amount of a nonpolar solvent having a relatively low boiling point such as toluene, xylene, hexane, cyclohexane, or heptane as a dehydrating agent while removing the water by-produced in the reaction from the reaction system. It is also preferred to add a small amount of basic organic compound selected from pyridine, N,N-dimethyl-4-aminopyridine, and triethylamine as a catalyst. The addition reaction is generally performed at 10 to 100° C., preferably performed at 40 to 90° C. During the dehydration ring-closing reaction, the reaction temperature is generally 150 to 220° C., preferably 160 to 200° C., and the reaction time is generally 2 to 15 hours, preferably 5 to 10 hours. The amount of a dehydrating agent added is generally 5 to 20% by weight based on a reaction solution, and the amount of a catalyst added is generally 0.1 to 5% by weight based on a reaction solution.

After the dehydration ring-closing reaction, the polyimide resin (A) of the present invention is obtained as a varnish in which the polyimide resin (A) of the present invention is dissolved in a solvent. An embodiment of the method for obtaining the polyimide resin (A) of the present invention includes a method in which a poor solvent such as water and alcohol is added to the resulting varnish to precipitate the polyimide resin (A) to purify the same. Further, another embodiment includes a method in which a varnish of the polyimide resin (A) of the present invention obtained after the dehydration ring-closing reaction is used as it is without purifying the varnish. The latter embodiment is more preferred from the point of view of operability.

The content of the polyimide resin (A) contained in the binder resin (“binder resin” in the present invention means a resin component containing no solvent component, for binding conductive particles in a film after coating and drying) is generally 50% by weight or more and 100% by weight or less, preferably 70% by weight or more and 99% by weight or less, more preferably 80% by weight or more and 95% by weight or less, based on the total weight of the binder resin, from the point of view of the reduction in electrical resistivity. When the content of the polyimide resin (A) is 50% by weight or more, the conductive paste where the conductive particles can be sintered at low temperatures can be obtained, and the conductive material having low electrical resistivity by the low-temperature heating can be formed from the conductive paste.

An epoxy resin can be incorporated into the binder resin. The epoxy resin in this case may be any epoxy resin as long as it is compatible with the polyimide resin (A), and the epoxy resin generally has one or more oxirane groups, preferably has one or more and four or less functional groups. Note that when the binder resin contains an epoxy resin, the polyimide resin (A) acts as a curing agent of this epoxy resin.

With the conductive paste of the present invention, silver particles can be sintered at a lower temperature, which is a preferred embodiment of the present invention to be described below, due to incorporation of an epoxy resin into the binder resin. Examples of the epoxy resin that can be incorporated into the binder resin include, but are not particularly limited to, any epoxy resin having an aromatic ring such as a benzene ring, a biphenyl ring, and a naphthalene ring and having one or more epoxy groups in one molecule. Specific examples include, but are not limited to, a novolac type epoxy resin, a xylylene skeleton-containing phenol novolac type epoxy resin, a biphenyl skeleton-containing novolac type epoxy resin, a bisphenol A type epoxy resin, a bisphenol F type epoxy resin, and a tetramethyl biphenol type epoxy resin. Note that the compatibility in the present embodiment refers to a state where even when a mixed solution of the polyimide resin (A) and an epoxy resin is allowed to stand for 12 hours at room temperature (25° C.), the epoxy resin is not separated from the polyimide resin (A). The content of the epoxy resin contained in the binder resin is generally 50% by weight or less, preferably 1% by weight or more and 30% by weight or less, more preferably 5% by weight or more and 20% by weight or less, based on the total weight of the binder resin.

When an epoxy resin is used in combination in the conductive paste of the present invention, a curing agent other than the polyimide resin (A) of the present invention may be used in combination. Specific examples of the curing agent that may be used in combination include, but are not limited to, diaminodiphenylmethane, diethylenetriamine, triethylenetetramine, diaminodiphenyl sulfone, isophoronediamine, dicyandiamide, a polyamide resin synthesized from a dimer of linolenic acid and ethylenediamine, phthalic anhydride, trimellitic anhydride, pyromellitic dianhydride, maleic anhydride, tetrahydrophthalic anhydride, methyltetrahydrophthalic anhydride, methylnadic anhydride, hexahydrophthalic anhydride, methylhexahydrophthalic anhydride, phenol novolac, triphenylmethane, and modified products thereof, imidazole, a BF₃-amine complex, and a guanidine derivative. When these curing agents are used in combination, the proportion of the polyimide resin (A) used in the present invention in the whole curing agents is generally 20% by weight or more, preferably 30% by weight or more.

The amount of an epoxy resin used when the epoxy resin is used in combination is preferably in a range where the active hydrogen equivalent of the polyimide resin (A) of the present invention and a curing agent that can optionally be used is 0.7 to 1.2 based on one equivalent of the epoxy groups of the epoxy resin. If the active hydrogen equivalent is less than 0.7 or more than 1.2 based on one equivalent of the epoxy groups, the curing may be imperfect, and good cured product properties may not be obtained.

Further, when an epoxy resin is used in combination, a curing accelerator may further be used in combination. Specific examples of the curing accelerator that can be used in combination include imidazoles such as 2-methylimidazole, 2-ethylimidazole, 2-ethyl-4-methylimidazole, 2-phenyl-4,5-dihydroxymethylimidazole, and 2-phenyl-4-methyl-5-hydroxymethylimidazole; tertiary amines such as 2-(dimethylaminomethyl)phenol and 1,8-diaza-bicyclo(5,4,0)undecene-7; phosphines such as triphenylphosphine; and organometallic compounds such as tin octylate. The curing accelerator is used as needed in an amount of 0.1 to 5.0 parts by weight based on 100 parts by weight of the epoxy resin.

Other resins contained in the binder resin are not particularly limited as long as they are resins generally used as a binder resin of a conductive paste. Examples include a melamine resin, an epoxy-modified acrylic resin, an acrylic resin, an unsaturated polyester resin, a phenolic resin, and an alkyd resin.

Examples of the conductive particles that can be used in the present invention include particles of elemental metal such as silver, gold, copper, aluminum, nickel, platinum, and palladium, an alloy containing such metals, and multi-layer metallic particles in which copper is covered with silver. In particular, silver-based conductive particles having low specific resistance are preferred, and among others, silver particles having a shortest diameter of 1 μm or more (hereinafter referred to as silver microparticles) are more preferred.

Examples of the shape of the silver microparticles include, but are not particularly limited to, a plate shape, a spherical shape, and an indefinite shape. Examples of the plate shape include a flake (thin piece) shape and a scale shape. The spherical shape means a sphere, but does not necessarily mean a true sphere as will be described below. Further, examples of the indefinite shape include a powder shape. Among these, plate-shaped silver microparticles are preferred, and flake-shaped silver microparticles are more preferred, from the point of view of increasing the contact area of silver particles to facilitate sintering at low temperatures. Note that in the present specification, “silver particles having a shortest diameter of 1 μm or more” with respect to the plate-shaped silver particles mean silver particles having a shortest diameter of 1 μm or more in the surface part of the plate-shaped silver particles, and such silver particles are also included in silver microparticles.

Generally, it is considered that since particles contained in a conductive paste comprising silver microparticles are hardly sintered by low-temperature heating as compared with a conductive paste comprising nano-sized silver particles, it is difficult to form a conductive material having low electrical resistivity by heating at low temperatures. However, since the conductive paste according to the present invention comprises silver microparticles and the polyimide resin (A), the silver microparticles can be sintered at low temperatures, and the formation of a conductive material having low electrical resistivity is achieved by low-temperature heating. This is probably because a binder resin containing the polyimide resin (A) serves to accelerate the sintering of silver microparticles.

Note that since the conductive paste according to the present invention is easily sintered even by low-temperature heating, and is easily sintered to the vicinity of the central part of the formed conductive material even when it is used in a large amount, the paste may be used for forming a thick conductive material (for example, 80 μm or more). On the other hand, in a conductive paste forming known nano-sized silver particles, when the amount of the paste used per unit area is increased as described above, the sintering of silver particles does not proceed in the vicinity of the central part of the formed conductive material, and sufficient electrical conductivity cannot be obtained. Therefore, it is difficult to use the paste for forming a thick conductive material.

In the present specification, the sintering by low-temperature heating means the sintering at a sintering temperature of 200° C. or less.

Further, the particles of a silver-containing alloy may be used as long as the main component of the particles is composed of silver. “The main component is composed of silver” means that 80% by weight or more of silver particles are composed of silver.

Silver microparticles having different shapes may be used in combination. When one or more silver microparticles selected from plate-shaped silver microparticles, spherical silver microparticles, and indefinite-shaped silver microparticles are used, plate-shaped silver microparticles are contained in an amount of preferably 5% by weight or more and 90% by weight or less, more preferably 30% by weight or more and 80% by weight or less, further preferably 40% by weight or more and 60% by weight or less, based on the whole silver microparticles.

The specific surface area of the plate-shaped silver microparticles is preferably 0.2 m²/g or more and 3.0 m²/g or less, more preferably 0.4 m²/g or more and 2.0 m²/g or less. The average particle size of the plate-shaped silver microparticles (average size of the plate-shaped plane) is preferably 2 μm or more and 15 μm or less, more preferably 3 μm or more and 10 μm or less. Examples of the plate-shaped silver microparticles available from the market include AgC-A, Ag-XF301, and AgC-224 (all are manufactured by Fukuda Metal Foil & Powder Co., Ltd.), and AgC-A which is flake-shaped can suitably be used.

In the spherical silver microparticles, the sphere does not necessarily mean a true sphere, but may be a sphere having unevenness on the surface. The specific surface area of the spherical silver microparticles is preferably 0.1 m²/g or more and 1.0 m²/g or less, more preferably 0.3 m²/g or more and 0.5 m²/g or less. The average particle size is preferably 1 μm or more and 10 μm or less, more preferably 2 μm or more and 5 μm or less. Examples of the spherical silver microparticles available from the market include Ag-HWQ having a diameter of 5 μm, Ag-HWQ having a diameter of 2.5 μm, and Ag-HWQ having a diameter of 1.5 μm (all are manufactured by Fukuda Metal Foil & Powder Co., Ltd.).

The indefinite-shaped silver microparticles include powdered silver microparticles, and examples thereof include electrolytic powder and chemically reduced powder, in which the main component is silver. The specific surface area of the indefinite-shaped silver microparticles is preferably 0.1 m²/g or more and 3.0 m²/g or less, more preferably 0.5 m²/g or more and 1.5 m²/g or less. The average particle size which can be used is preferably 1 μm or more and 10 μm or less, more preferably 3 μm or more and 5 μm or less. Examples of the indefinite-shaped silver microparticles available from the market include AgC-156I, AgC-132, and AgC-143 (all are manufactured by Fukuda Metal Foil & Powder Co., Ltd.).

The specific surface area of silver microparticles is measured by the BET method in which a predetermined glass container is filled with powder and the physical adsorption of nitrogen gas is utilized. For example, the specific surface area can be measured by using TriStar II3020 (manufactured by Shimadzu Corporation).

The average particle size of silver microparticles is determined by drawing cumulative distribution based on the particle size range of the measured particle size distribution and determining the average particle size as a particle size (volume average particle size) when the accumulated volume of particles is 50% in the cumulative distribution. For example, the particle size distribution can be measured using Microtrac MT3300 (manufactured by Nikkiso Co., Ltd.).

The content of silver microparticles based on the total solid content of the conductive paste is 70% by weight or more and 95% by weight or less, preferably 80% by weight or more and 90% by weight or less, more preferably 85% by weight. It is conceivable that when the content of silver microparticles based on the total solid content of the conductive paste is 70% by weight or more, the electrical resistivity of a conductive material to be formed can be reduced. Further, it is conceivable that when the content of silver microparticles based on the total solid content of the conductive paste is 95% by weight or less, the adhesive force of the conductive paste can be secured, and a crack of a conductive material to be formed can be suppressed.

The conductive paste of the present invention may comprise, together with silver microparticles and a binder resin, a solvent for dissolving or stably dispersing the binder resin and for adjusting the viscosity of the paste, but the solvent is not particularly limited. Examples of the solvent include amide-based solvents such as γ-butyrolactone, N-methylpyrrolidone (NMP), N,N-dimethylformamide (DMF), N,N-dimethylacetamide, and N,N-dimethylimidazolidinone; sulfones such as tetramethylene sulfone; ether-based solvents such as diethylene glycol dimethyl ether, diethylene glycol diethyl ether, propylene glycol, propylene glycol monomethyl ether, propylene glycol monomethyl ether monoacetate, and propylene glycol monobutyl ether; ketone-based solvents such as methyl ethyl ketone, methyl isobutyl ketone, cyclopentanone, and cyclohexanone; aromatic solvents such as toluene and xylene; and mixtures thereof.

The heating temperature during forming a conductive material from the conductive paste of the present invention is preferably 150° C. or more and 200° C. or less, for example when the electrical resistivity of the conductive material formed is set to 10 μΩcm or less. Here, the heating temperature refers to the ambient temperature in a heating zone. When the conductive paste of the present invention is heated at 200° C. or less, the silver particles are sintered, and a conductive material having an electrical resistivity of 10 μΩcm or less can be formed. When a conductive material having an electrical resistivity of more than 10 μΩcm and 20 μΩcm or less is formed, the conductive paste of the present invention may be heated at 120° C. or more and less than 180° C. The heating time of the conductive paste, which changes with the heating temperature or the amount of the conductive paste, is generally 5 minutes or more and 60 minutes or less, preferably 30 minutes or more and 60 minutes or less. Note that when an epoxy resin is contained in a binder resin, it is conceivable that the conductive material having the above electrical resistivity can be formed at a further lower heating temperature.

Examples of the applications of the conductive paste of the present invention include various applications requiring electrical conductivity and adhesive properties, such as connection of wirings requiring electrical conductivity, adhesion of members, and formation of electrodes and wirings. Specific applications of the conductive paste of the present invention include die attachment, surface mounting of chip components, via filling, print formation of circuits for membrane wiring boards, and the like, and antenna formation in RF-ID, noncontact IC cards, and the like. In particular, since the silver particles contained in the conductive paste of the present invention are sintered by low-temperature heating and can form a conductive material having low electrical resistivity, the paste is suitable for forming a conductive material on a substrate having low heat resistance in which solder cannot be used, for example, a substrate composed of a material such as polyethylene terephthalate, polybutylene terephthalate, and polyethylene terephthalate, and the reduction in cost is also achieved by improving the selectivity of the substrate.

The electrical resistivity of the formed conductive material was measured as follows. A paste was applied to an insulating substrate made of inorganic glass such as silicate glass, a ceramic such as alumina, or an organic polymer film such as polyimide and cured under a predetermined heating condition. Subsequently, the electrical resistivity was measured by a constant current method such as a four-terminal method, a four-point probe method, and a van der Pauw method in the manner in which the influence of the contact resistance of a lead wire and a probe is eliminated.

When a coupling agent is added to the conductive paste of the present invention, it is expected to improve the dispersibility of silver particles in the paste and adhesion to a binder resin. The type of the coupling agent is not particularly limited, and a known coupling agent, such as a silane-based, a titanate-based, and an aluminate-based coupling agent, may be added as needed. Further, the amount of the coupling agent added may arbitrarily be set in consideration of the amount of the conductive particles and the binder resin blended.

The production method of the conductive paste of the present invention is not particularly limited as long as the production is performed with an apparatus in which a binder resin, conductive particles, and other additives added as needed, such as a curing agent, a curing accelerator, a solvent, and a coupling agent, can uniformly be kneaded and mixed. Examples of the apparatus that can be used include a kneading apparatus such as a kneader, a triple roll mill, and a grinding machine, and a planetary mixer.

In order to sheet the conductive paste of the present invention to obtain the conductive film of the present invention, the conductive paste of the present invention may be applied to a release film by a known coating method, such as a flow coating method, a spray coating method, a bar coating method, a gravure coating method, a roll coating method, a blade coating method, an air knife coating method, a lip coating method, and a die coater method, followed by drying. The release film used in the present invention may be made of a substance that can hold a conductive layer formed from a conductive paste on the surface thereof and can easily be peeled when the conductive layer is used, and a synthetic resin, paper, or a substance in which a synthetic resin and paper are combined can be used as a material.

### EXAMPLES

The present embodiment will be described further specifically with reference to Examples below, but the present embodiment is not intended to be limited to these Examples.

### Synthesis Example 1

A 500-ml reactor equipped with a thermometer, a reflux condenser, a Dean-Stark apparatus, a powder inlet port, a nitrogen-introducing device, and a stirrer was charged with 30.79 parts (0.105 mol) of APB-N (1,3-bis-(3-aminophenoxy)benzene, manufactured by Mitsui Chemicals, Inc., molecular weight: 292.33) as a diamine compound and 0.467 parts (0.0017 mol) of ABPS (3,3′-diamino-4,4′-dihydroxydiphenylsulfone, manufactured by Nippon Kayaku Co., Ltd., molecular weight: 280.30). Thereto was added 68.58 parts of γ-butyrolactone as a solvent while passing dry nitrogen, followed by stirring for 30 minutes at 70° C. Subsequently, thereto were added 32.54 parts (0.105 mol) of ODPA (4,4′-oxydiphthalic anhydride, manufactured by Manac Incorporated, molecular weight: 310.22) as a tetracarboxylic dianhydride, 71.40 parts of γ-butyrolactone as a solvent, 1.66 parts of pyridine as a catalyst, and 28.49 parts of toluene as a dehydrating agent, and the inside temperature of the reactor was raised to 180° C. The ring-closing reaction was performed by heating for 3 hours at 180° C. while removing water generated by imidization reaction using the Dean-Stark apparatus. Subsequently, the heating was performed for further 4 hours to remove pyridine and toluene. After the completion of the reaction, the reaction mixture cooled to 80° C. or less was subjected to filtration under pressure using a Teflon (registered trademark) filter having a pore size of 3 μm to thereby obtain 200 parts of a varnish containing the polyimide resin of the present invention, the varnish containing 30% by weight of the polyimide resin (A) of the present invention represented by the following formula (8):

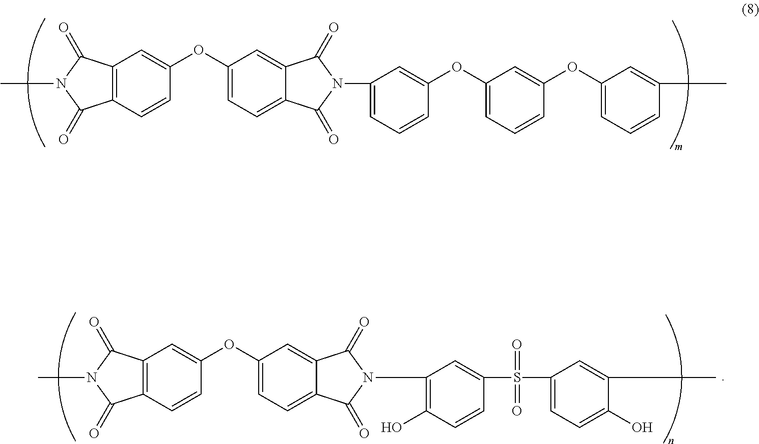

The number average molecular weight and the weight average molecular weight determined in terms of polystyrene based on the results of the gel permeation chromatography measurement of the polyimide resin (A) of the present invention in the polyimide resin varnish were 36,000 and 97,000, respectively. The values of m and n in the formula (8) calculated from the molar ratio of each component used in the synthetic reaction were 49.22 and 0.78, respectively.

### Synthesis Example 2

A 500-ml reactor equipped with a thermometer, a reflux condenser, a Dean-Stark apparatus, a powder inlet port, a nitrogen-introducing device, and a stirrer was charged with 30.63 parts (0.105 mol) of APB-N (1,3-bis-(3-aminophenoxy)benzene, manufactured by Mitsui Chemicals, Inc., molecular weight: 292.33) as a diamine compound and 0.623 parts (0.0022 mol) of ABPS (3,3′-diamino-4,4′-dihydroxydiphenylsulfone, manufactured by Nippon Kayaku Co., Ltd., molecular weight: 280.30). Thereto was added 68.58 parts of γ-butyrolactone as a solvent while passing dry nitrogen, followed by stirring for 30 minutes at 70° C. Subsequently, thereto were added 32.54 parts (0.105 mol) of ODPA (4,4′-oxydiphthalic anhydride, manufactured by Manac Incorporated, molecular weight: 310.22) as a tetracarboxylic dianhydride, 71.41 parts of γ-butyrolactone as a solvent, 1.66 parts of pyridine as a catalyst, and 28.49 parts of toluene as a dehydrating agent, and the inside temperature of the reactor was raised to 180° C. The ring-closing reaction was performed by heating for 3 hours at 180° C. while removing water generated by imidization reaction using the Dean-Stark apparatus. Subsequently, the heating was performed for further 4 hours to remove pyridine and toluene. After the completion of the reaction, the reaction mixture cooled to 80° C. or less was subjected to filtration under pressure using a Teflon (registered trademark) filter having a pore size of 3 μm to thereby obtain 200 parts of a polyimide resin varnish of the present invention, the varnish containing 30% by weight of the polyimide resin (A) of the present invention represented by the following formula (8):

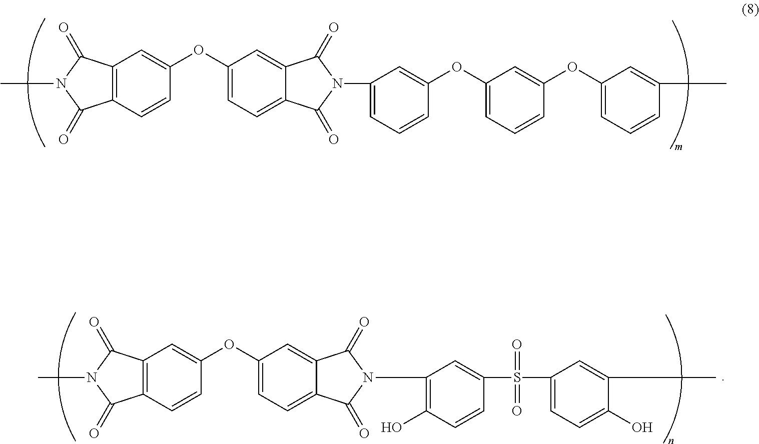

The number average molecular weight and the weight average molecular weight determined in terms of polystyrene based on the results of the gel permeation chromatography measurement of the polyimide resin (A) of the present invention in the polyimide resin varnish were 38,000 and 102,000, respectively. The values of m and n in the formula (8) calculated from the molar ratio of each component used in the synthetic reaction were 48.96 and 1.04, respectively.

### Example 1

### Preparation of Conductive Paste

To 100 g of the polyimide resin (A) varnish obtained in Synthesis Example 1 as a binder resin, were added 8 g of epoxy resin RE602S (manufactured by Nippon Kayaku Co., Ltd.) and 7 g of epoxy resin BLEMMER G (manufactured by NOF CORPORATION), 0.3 g of 2-phenyl-4,5-dihydroxymethylimidazole (2PHZ) as a curing accelerator, and 54 g of N,N-dimethylformamide as a solvent, and these components were mixed using a defoaming planetary mixer. Then, thereto was further added 206 g of plate-shaped silver microparticles AgC-A (manufactured by Fukuda Metal Foil & Powder Co., Ltd.) followed by mixing to obtain a conductive paste of the present invention.

### <Preparation of Conductive Film>

The conductive paste prepared as described above was applied in a rectangular pattern to a substrate composed of silicate glass, subjected to heat treatment for 60 minutes at a temperature of 200° C. in a heating oven, and allowed to cool at room temperature (25° C.) to obtain a conductive film of the present invention.

### Example 2

### Preparation of Conductive Paste

A conductive paste of the present invention was obtained by performing experiments in the same manner as in Example 1 except that the polyimide resin (A) varnish obtained in Synthesis Example 2 was used as a varnish of a polyimide resin (A) to be used as a binder resin.

### <Preparation of Conductive Film>

The conductive paste prepared as described above was applied in a rectangular pattern to a substrate composed of silicate glass, subjected to heat treatment for 60 minutes at a temperature of 200° C. in a heating oven, and allowed to cool at room temperature (25° C.) to obtain a conductive film of the present invention.

### Comparative Example 1

### Preparation of Conductive Paste

To 100 g of epoxy resin RE602S (manufactured by Nippon Kayaku Co., Ltd.) as a binder resin, were added 2.0 g of 2-phenyl-4,5-dihydroxymethylimidazole (2PHZ) as a curing accelerator and 286 g of N,N-dimethylformamide as a solvent, and these components were mixed using a defoaming planetary mixer. Then, thereto was further added 478 g of plate-shaped silver microparticles AgC-A (manufactured by Fukuda Metal Foil & Powder Co., Ltd.) followed by mixing to obtain a conductive paste.

### <Preparation of Conductive Film>

The conductive paste prepared as described above was applied in a rectangular pattern to a substrate composed of silicate glass, subjected to heat treatment for 60 minutes at 200° C. in a heating oven, and allowed to cool at room temperature (25° C.) to obtain a conductive film for comparison.

### Comparative Example 2

### Preparation of Conductive Paste

To 300 g of urethane resin DF-407 (manufactured by DIC Corporation, solid content: 25% by weight) and 10 g of epoxy resin GAN (manufactured by Nippon Kayaku Co., Ltd.) as a binder resin, were added 0.2 g of 2-phenyl-4,5-dihydroxymethylimidazole (2PHZ) as a curing accelerator and 7.5 g of N,N-dimethylformamide as a solvent, and these components were mixed using a defoaming planetary mixer. Then, thereto was further added 387 g of plate-shaped silver microparticles AgC-A (manufactured by Fukuda Metal Foil & Powder Co., Ltd.) followed by mixing to obtain a conductive paste.

### <Preparation of Conductive Film>

The conductive paste prepared as described above was applied in a rectangular pattern to a substrate composed of silicate glass, subjected to heat treatment for 60 minutes at a temperature of 200° C. in a heating oven, and allowed to cool at room temperature (25° C.) to obtain a conductive film for comparison.

### Comparative Example 3

### Preparation of Conductive Paste

To 150 g of 20% by weight U-varnish (manufactured by Ube Industries, Ltd., N-methyl-2-pyrrolidone as a solvent) which is a commercially available polyimide precursor (polyamic acid) varnish, 8 g of epoxy resin RE602S (manufactured by Nippon Kayaku Co., Ltd.), and 7 g of epoxy resin BLEMMER G (manufactured by NOF CORPORATION), as a binder resin, were added 0.3 g of 2-phenyl-4,5-dihydroxymethylimidazole (2PHZ) as a curing accelerator and 54 g of N,N-dimethylformamide as a solvent, and these components were mixed using a defoaming planetary mixer. Then, thereto was further added 206 g of plate-shaped silver microparticles AgC-A (manufactured by Fukuda Metal Foil & Powder Co., Ltd.) followed by mixing to obtain a conductive paste of Comparative Example 3.

### <Preparation of Conductive Film>

The conductive paste prepared as described above was applied in a rectangular pattern to a substrate composed of silicate glass, subjected to heat treatment for 60 minutes at a temperature of 200° C. in a heating oven, and allowed to cool at room temperature (25° C.) to obtain a conductive film for comparison.

### Comparative Example 4

### Preparation of Conductive Paste

To 150 g of 20% by weight of RICACOAT SN-20 (manufactured by New Japan Chemical Co., Ltd., N-methyl-2-pyrrolidone as a solvent) which is a commercially available polyimide varnish, 8 g of epoxy resin RE602S (manufactured by Nippon Kayaku Co., Ltd.), and 7 g of epoxy resin BLEMMER G (manufactured by NOF CORPORATION), as a binder resin, were added 0.3 g of 2-phenyl-4,5-dihydroxymethylimidazole (2PHZ) as a curing accelerator and 54 g of N,N-dimethylformamide as a solvent, and these components were mixed using a defoaming planetary mixer. Then, thereto was further added 206 g of plate-shaped silver microparticles AgC-A (manufactured by Fukuda Metal Foil & Powder Co., Ltd.) followed by mixing to obtain a conductive paste of Supplementary Test Example 2.

### <Preparation of Conductive Material>

The conductive paste prepared as described above was applied in a rectangular pattern to a substrate composed of silicate glass, subjected to heat treatment for 60 minutes at a temperature of 200° C. in a heating oven, and allowed to cool at room temperature (25° C.) to obtain a conductive material.

### [Measurement of Volume Resistivity]

The samples obtained in Preparation of Conductive Film as described above were used to measure the volume resistivity using a low resistivity meter Loresta GP (manufactured by Mitsubishi Chemical Corporation). The results are shown in Table 1.

### [Measurement of Glass Transition Temperature Tg]

The samples obtained in Preparation of Conductive Film as described above were used to measure the glass transition temperature (DMA-Tg) using a dynamic viscoelasticity measurement device DMS6100 (manufactured by Seiko Instruments Inc.). The results are shown in Table 1.

### [Solder Bath Heat Resistance Test]

A copper foil and an aluminum foil each having a thickness of 18 μm were prepared as an adherend. The conductive paste obtained in Preparation of Conductive Paste as described above was applied between the copper foil and the aluminum foil and subjected to curing reaction for 1 hour at a temperature of 200° C. and a pressure of 3 MPa to bond the foils. Next, the prepared sample was floated for 2 minutes on a solder bath heated to 340° C. and checked for the change in appearance (blisters, peeling, and the like). When there was no change in appearance, the heat resistance was rated as ◯ (good), and when there was a change in appearance, the heat resistance was rated as X (poor). The results are shown in Table 1.

### [Measurement of Shear Strength]

A copper sheet and an aluminum sheet each having a thickness of 2 mm were prepared as an adherend. The conductive paste obtained in Preparation of Conductive Paste as described above was applied between the copper sheet and the aluminum sheet and subjected to curing reaction for 1 hour at a temperature of 200° C. and a pressure of 3 MPa to bond the sheets. The shear strength was measured according to JIS-K6850 using a tensile testing machine Autograph A6 (manufactured by Shimadzu Corporation). The measurement was performed at ordinary temperature and a shear rate of 50 mm/min. The results are shown in Table 1.

### [Adhesion Reliability Test]

A copper sheet and an aluminum sheet each having a thickness of 2 mm were prepared as an adherend. The conductive paste obtained in Preparation of Conductive Paste as described above was applied between the copper sheet and the aluminum sheet and subjected to curing reaction for 1 hour at a temperature of 200° C. and a pressure of 3 MPa to bond the sheets. The prepared sample was subjected to a heat cycle test, and after the test, the bonded surface was observed by SAT (ultrasonic image analysis) and checked for whether there was any delamination or not. The results are shown in Table 1. In the heat cycle test, a sample was held at −40° C. for 15 minutes, followed by temperature rise, and then held at 150° C. for 15 minutes. This operation was defined as one cycle, and the operation was repeated 1000 cycles. The results are shown in Table 1.

TABLE 1

| | | | Comparative | Comparative | Comparative | Comparative |
|---|---|---|---|---|---|---|
| | Example 1 | Example 2 | Example 1 | Example 2 | Example 3 | Example 4 |
| Volume resistivity | 8.7 | 8.8 | 9.7 | 8.8 | 230 | 110 |
| (μΩcm) | | | | | | |
| DMA-Tg (° C.) | 190 | 190 | 155 | 95 | 340 | 210 |
| Solder bath heat | ∘ | ∘ | x | x | x | x |
| resistance test | | | | | | |
| Shear strength | 9.9 | 10.5 | <1 | <1 | <1 | <1 |
| (MPa) | | | | | | |
| Adhesion | No | No | Delamination | Delamination | Delamination | Delamination |
| reliability test | delamination | delamination | | | | |

The results in Table 1 have shown that the conductive paste (or conductive film) of the present invention has low volume resistivity, is excellent in heat resistance because the solder bath heat resistance test was satisfactory, and is excellent in adhesive properties because the shear strength was high and no delamination occurred in the adhesion reliability test.

1. A conductive paste comprising: a binder resin containing at least one aromatic polyimide resin (A) having an ether linkage and a phenolic hydroxyl group in a skeleton; and conductive particles.

2. The conductive paste according to claim 1, wherein the aromatic polyimide resin (A) is represented by the following formula (1): 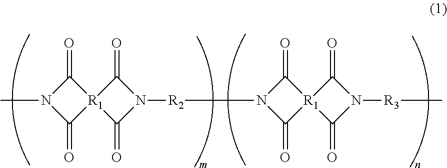
wherein m and n are each an average value of the number of repeating units and a positive number satisfying the relations of 0.005<n/(m+n)<0.14 and 0<m+n<200; R₁ represents a tetravalent aromatic group represented by the following formula (2): 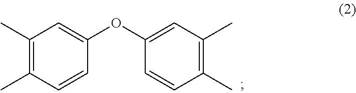
R₂ represents a divalent aromatic group represented by the following formula (3): 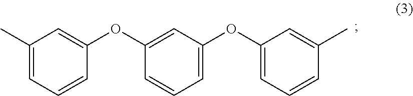
and
R₃ represents one or more divalent aromatic groups selected from structures represented by the following formula (4):

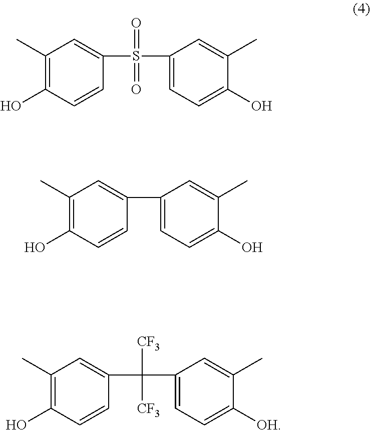

3. The conductive paste according to claim 1, wherein the content of the aromatic polyimide resin (A) is 50% by weight or more and 100% by weight or less based on the total weight of the binder resin.

4. The conductive paste according to claim 1, wherein the binder resin further contains an epoxy resin.

5. The conductive paste according to claim 4, wherein the content of the epoxy resin is 5% by weight or more and 50% by weight or less based on the binder resin.

6. The conductive paste according to claim 1, wherein the conductive particles are silver particles each having a shortest diameter of 1 μm or more.

7. The conductive paste according to claim 1, wherein the conductive particles comprise plate-shaped silver particles.

8. The conductive paste according to claim 7, wherein the silver particles further comprise at least one selected from spherical silver particles and indefinite-shaped silver particles.

9. A conductive film obtained by processing the conductive paste according to claim 1 into a sheet shape.
